(19) United States
(12) Patent Application Publication
(10) Pub. No.: US 2011/0168449 A1
(43) Pub. Date: Jul. 14, 2011

(54) METHODS FOR DRILLING, REAMING AND CONSOLIDATING A SUBTERRANEAN FORMATION

(76) Inventors: Ronald G. Dusterhoft, Katy, TX (US); Philip D. Nguyen, Duncan, OK (US)

(21) Appl. No.: 12/685,290

(22) Filed: Jan. 11, 2010

(51) Int. Cl. E21B 7/00; C09K 8/02; E21B 7/28; C09K 8/56

(52) U.S. Cl. 175/72

(57) ABSTRACT

Methods are provided including methods comprising providing a drill-in fluid, a reaming fluid, and a consolidating agent; drilling at least a portion of a subterranean formation with the drill-in fluid whereby a filter cake is formed on a surface of the subterranean formation; reaming at least a portion of the subterranean formation with the reaming fluid whereby at least a portion of the filter cake is removed; and consolidating at least a portion of the subterranean formation with the consolidating agent. Other methods are also provided.

### BACKGROUND

The present invention relates to methods of drilling, reaming and consolidating a subterranean formation and, more particularly, in one or more embodiments, to drilling a well bore through a production zone within a subterranean formation, reaming the well bore using a reamer, and consolidating the near-well bore region.

When drilling into a subterranean formation to reach a producing zone, it is generally necessary to drill through a substantial distance of non-producing formation before reaching the desired zone or zones. When the wellbore is drilled through the non-producing sections, a drilling mud is pumped into the drill string within the well and is then drawn up to the surface of the well through the annulus surrounding the drill string. The drill cuttings are entrained in the drilling mud and withdrawn from the well with the fluid. In addition to removing cuttings, the drilling mud also serves other functions such as lubricating the drill string and bit, cooling the drill bit, and providing sufficient hydrostatic pressure down hole to prevent the flow of formation fluids into the well. Generally, the drilling mud is a liquid with solids suspended therein. The solids function to impart desired rheological properties to the drilling mud and also to increase its density in order to provide a suitable hydrostatic pressure at the bottom of the well. The drilling mud may be an aqueous-base mud, an oil-base mud, or compressed gas or air.

While drilling muds are highly effective and cost relatively little, they may not be suitable for drilling into the producing zone of a subterranean formation, particularly if the formation is highly permeable and/or weak. This is because the make-up of the drilling mud tends to damage the producing formation and tends to complicate the completion process. For these reasons, specially formulated “drill-in” compositions may be used to drill the wellbore into producing portions of a subterranean formation so as to minimize damage and maximize production of exposed zones and to facilitate any necessary well completion needed. Unlike a drilling fluid, a drill-in fluid generally contains few solids, and what solids it does contain are often size controlled to minimize penetration or invasion into the formation matrix to avoid damaging the production formation. Generally, only those additives needed for filtration control and cuttings carrying are present in a drill-in fluid. These solids are designed to be removed physically or chemically after one or more completion operations before the well is put on production.

In the drilling of oil and gas wells, it is frequently necessary or desirable to “ream” a borehole that has been previously created by a drill bit or other cutting tool so as to remove formation projections that may have survived the first pass of the drilling assembly, to enlarge the hole to facilitate placement of larger casing or a gravel pack, or to clear debris or other material from deep inside the well, thereby providing a relatively smooth and more uniform borehole wall surface. In certain applications, a reamer is placed behind the drill bit on the drilling assembly so as to ream the hole immediately after the bit has formed the borehole. It is sometimes preferred that such a reaming step be performed as the bit is being withdrawn from the borehole, such process being referred to as “backreaming.” An alternative to backreaming is to withdraw the bit and then run into the hole a drill string having a reamer on the end.

After a well is drilled into a portion of a subterranean formation, a variety of stimulation and completion operations may be performed before placing the well into production. One common operation involves consolidating the formation particulates to minimize the production of solids along with the desired fluids. In addition to maintaining a relatively solids-free production stream, consolidating particulates also aids in protecting the production flow paths of the formation. Flow of unconsolidated particulate material, such as formation fines, through the conductive channels in a subterranean formation tends to clog the conductive channels and may damage the interior of the formation or equipment.

There are several known techniques used to control particulate migration, some of which may involve the use of consolidating agents. The term “consolidating agent” as used herein includes any compound that is capable of minimizing particulate migration in a subterranean formation and/or modifying the stress-activated reactivity of subterranean fracture faces and other surfaces in subterranean formations. Such consolidating agents may be used once the drill-in process is complete by placing the consolidating agent into the formation such that it coats the unconsolidated particulates, making them adhere to one another and to consolidated matter within the formation such that the coated particulates are less likely to migrate through the conductive channels in the subterranean formation.

### SUMMARY

The present invention relates to methods of drilling, reaming and consolidating a subterranean formation and, more particularly, in one or more embodiments, to drilling a well bore through a production zone within a subterranean formation, reaming the well bore using a reamer, and consolidating the near-well bore region.

In one embodiment, the methods of the present invention comprise providing a drill-in fluid, a reaming fluid, and a consolidating agent; drilling at least a portion of a subterranean formation with the drill-in fluid whereby a filter cake is formed on a surface of the subterranean formation; reaming at least a portion of the subterranean formation with the reaming fluid whereby at least a portion of the filter cake is removed; and consolidating at least a portion of the subterranean formation with the consolidating agent.

In another embodiment, the methods of the present invention comprise providing a drill-in fluid comprising a consolidating agent; providing a reaming fluid; drilling at least a portion of a subterranean formation with the drill-in fluid comprising the consolidating agent; allowing the consolidating agent to penetrate a surface of the subterranean formation so as to form a consolidated region; allowing a filter cake to form on the surface of the subterranean formation; and reaming at least a portion of the subterranean formation with the reaming fluid so as to remove at least a portion of the filter cake and expose at least a portion of the consolidated region.

In yet another embodiment, the methods of the present invention comprise providing a drill-in fluid; providing a reaming fluid comprising a consolidating agent; drilling at least a portion of a subterranean formation with the drill-in fluid; allowing a filter cake to form on the surface of the subterranean formation; reaming at least a portion of the subterranean formation with the reaming fluid comprising the consolidating agent; and allowing the consolidating agent to penetrate a surface of the subterranean formation so as to form a consolidated region.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is a cross-sectional, side view of a well bore penetrating an interval of a subterranean formation showing the introduction of a drill-in fluid comprising a consolidating agent into the well bore, in accordance with one embodiment of the present invention.

FIG. 2 is a cross-sectional, side view of a well bore penetrating an interval of a subterranean formation showing the introduction of a reaming fluid and reaming of a portion of the well bore of FIG. 1, in accordance with one embodiment of the present invention.

FIG. 3 is a cross-sectional, side view of a well bore penetrating an interval of a subterranean formation showing the introduction of a drill-in fluid into the well bore, in accordance with one embodiment of the present invention.

FIG. 4 is a cross-sectional, side view of a well bore penetrating an interval of a subterranean formation showing the introduction of a reaming fluid comprising a consolidating agent into the well bore and reaming of a portion of the well bore of FIG. 3, in accordance with one embodiment of the present invention.

FIG. 5 is a graph depicting unconfined compressive strength (UCS) values of core plugs from core wafers, in accordance with one embodiment of the present invention.

FIG. 6 is a graph depicting loss-on-ignition (LOI) from core wafers, in accordance with one embodiment of the present invention.

### DESCRIPTION OF THE PREFERRED EMBODIMENTS

The present invention relates to methods of drilling, reaming and consolidating a subterranean formation and, more particularly, in one or more embodiments, to drilling a well bore through a production zone within a subterranean formation, reaming the well bore using a reamer, and consolidating the near-well bore region. Embodiments of the present invention relate to drilling a well bore through a production zone within an subterranean formation using a drill-in fluid, reaming the well bore using a reamer and a reaming fluid, and consolidating the near well-bore region of the well bore using a consolidating agent. In some embodiments, the consolidating agent may be a component of a drill-in fluid. In some embodiments, the consolidating agent may be a component of a reaming fluid.

One of the many potential advantages of the methods of the present invention is that they may allow, among other things, for the consolidation of a near-well bore region during a drill-in operation. In some embodiments, the methods of the present invention may strengthen weak formations so as to minimize or prevent hole stability problems for subsequent well operations. Furthermore, in some embodiments, the need for complex sand control completions can be eliminated and a well may be put on production using a simple open hole completion or an open hole completion with selective isolation packers and/or sleeves to control production from different intervals.

### I. Example Methods

In some embodiments, the methods of the present invention comprise providing a drill-in fluid, a reaming fluid, and a consolidating agent; drilling at least a portion of a subterranean formation with the drill-in fluid whereby a filter cake is formed on a surface of the subterranean formation; reaming at least a portion of the subterranean formation with the reaming fluid whereby at least a portion of the filter cake is removed; and consolidating at least a portion of the subterranean formation with the consolidating agent.

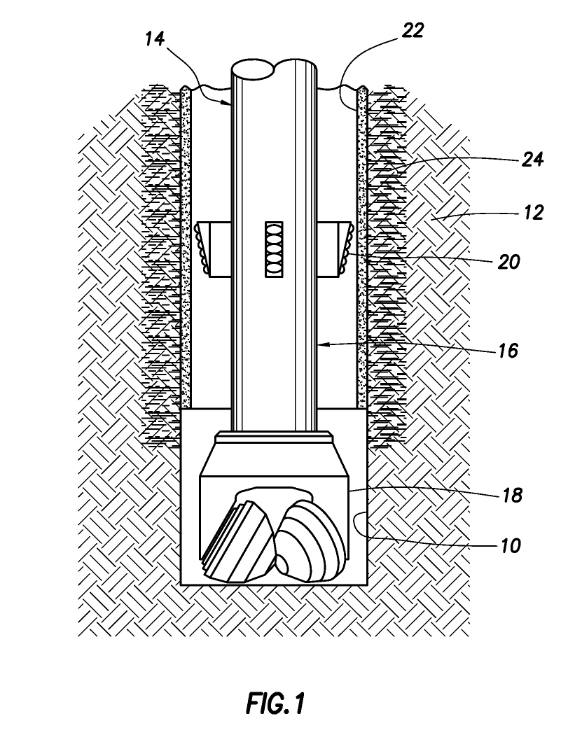

Turning to the drawings and referring first to FIG. 1, a well bore 10 is shown that penetrates an interval 12 of a subterranean formation. The interval 12 represents an interval that has been identified for drilling and consolidation in accordance with present embodiments. As will be appreciated by those of ordinary skill in the art, with the benefit of this disclosure, the interval 12 may be any interval of a subterranean formation. Even though FIG. 1 depicts the well bore 10 as a vertical well bore, the methods of certain embodiments may be suitable for use in generally horizontal, generally vertical, or otherwise formed portions of wells. Moreover, as those of ordinary skill in the art will appreciate, with the benefit of this disclosure, embodiments of the present invention may be applicable for the treatment of both production and injection wells. Additionally, while the well bore 10 is illustrated as an openhole well bore, embodiments of the present invention also may be suitable for partially cased well bores. For example, in some embodiments, the methods of the present invention may be performed below an intermediate casing string. As will be appreciated by those of ordinary skill in the art, with the benefit of this disclosure, even though FIG. 1 depicts the well bore 10 as being drilled with a drill pipe assembly comprising a drill string and a drill bit, well bore 10 may be created by any suitable method, including jet drilling. Examples of jet drilling may include those described in U.S. Pat. Nos. 4,119,160 and 6,668,948, both of which are incorporated by reference herein.

In FIG. 1, drill pipe assembly 14 is disposed in well bore 10. The drill pipe assembly 14 comprises a drill string 16, drill bit 18 and underreamer 20. According to one embodiment, a drill-in fluid comprising a consolidating agent is pumped down through drill string 16 and out through drill bit 18 while drilling a portion of well bore 10. While the well bore is being drilled, underreamer 20 is not actuated, i.e., it is in a retracted state. During drilling, the drill-in fluid comprising a consolidating agent exits drill bit 18 and leaks off into interval 12 of the subterranean formation so as to form filter cake 22 and consolidated region 24 in the near well-bore region. Those of ordinary skill in the art will understand that the “near well bore portion” of a formation generally refers to the portion of a subterranean formation surrounding a well bore. For example, the “near well bore portion” may refer to the portion of the formation surrounding a well bore and having a depth of penetration of from about 0.5 to about 3 well bore diameters.

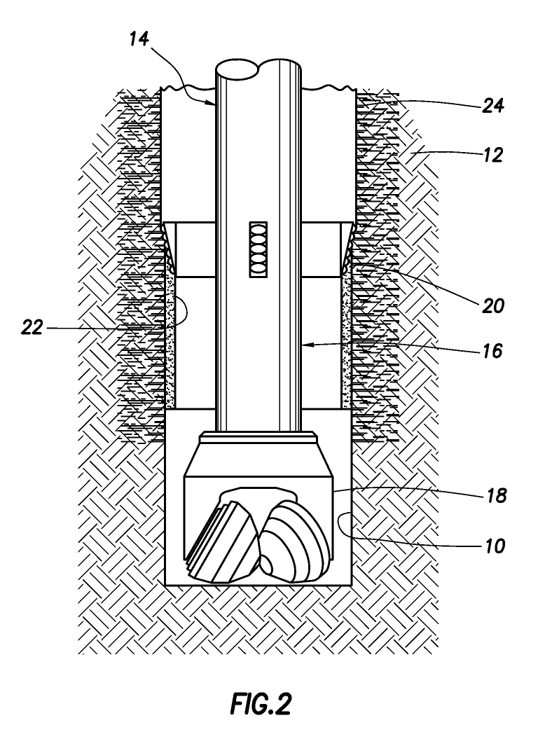

Referring now to FIG. 2, once filter cake 22 is formed, underreamer 20 is actuated and a reamer fluid may be pumped down through drill string 16 and out through drill bit 18. Underreamer 20 then reams the well bore so that at least a portion of filter cake 22 is removed to expose consolidated region 24. As those of ordinary skill in the art will appreciate, by forming a filter cake and then subsequently reaming the formation to remove at least a portion of the filter cake, consolidated region 24 may be exposed, which will generally have increased strength and good permeability.

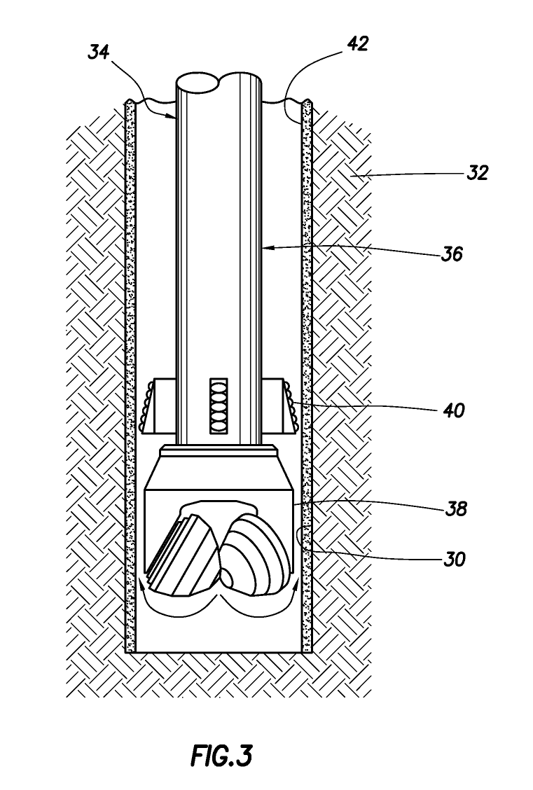

In another embodiment, depicted in FIG. 3, a well bore 30 is shown that penetrates an interval 32 of a subterranean formation. The interval 32 represents an interval that has been identified for drilling and consolidation in accordance with present embodiments. As will be appreciated by those of ordinary skill in the art, with the benefit of this disclosure, the interval 32 may be any interval of a subterranean formation. Even though FIG. 3 depicts the well bore 30 as a vertical well bore, the methods of certain embodiments may be suitable for use in generally horizontal, generally vertical, or otherwise formed portions of wells. Moreover, as those of ordinary skill in the art will appreciate, with the benefit of this disclosure, embodiments of the present invention may be applicable for the treatment of both production and injection wells. Additionally, while the well bore 30 is illustrated as an openhole well bore, embodiments of the present invention also may be suitable for partially cased well bores.

In FIG. 3, drill pipe assembly 34 is disposed in well bore 30. The drill pipe assembly 34 comprises drill string 36, drill bit 38 and backreamer 40. As shown in FIG. 3, backreamer 40 is not actuated during the initial drilling process. According to one embodiment, a drill-in fluid is pumped down through drill string 36 and out through drill bit 38. The drill-in fluid exits drill bit 38 while well bore 30 is being drilled, and the drill-in fluid leaks off into interval 32 of the subterranean formation so as to form a filter cake 42 in the near well-bore region.

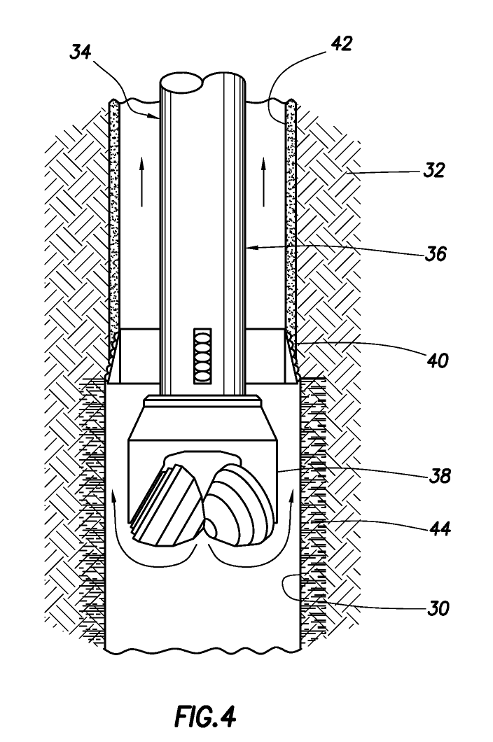

Referring now to FIG. 4, once the well bore has been drilled, a reamer fluid comprising a consolidating agent may be pumped down through drill string 36 and out through drill bit 38 while pulling drill string 36 out of the well bore. As drill string 36 is being removed from the well bore, backreamer 40 is actuated so as to ream at least a portion of the formation and remove at least a portion of filter cake 44. The reamer fluid comprising a consolidating agent leaks off into the newly exposed portion of the subterranean formation so as to form a consolidated region 44 in the near well-bore region.

### II. Suitable Drill-In Fluids

The drill-in fluids suitable for use in the present invention comprise an aqueous fluid and a viscosifying agent. In some embodiments, the drill-in fluid may also comprise a bridging agent.

Suitable aqueous fluids that may be used in the drill-in fluids suitable for use in the present invention include fresh water, salt water, brine, seawater, an aqueous fluid comprising a water soluble organic stabilizing compound, or any other aqueous fluid that, preferably, does not adversely react with the other components used in accordance with this invention or with the subterranean formation. In some preferred embodiments, the aqueous fluid comprises a brine.

Viscosifying agents that may be used in the drill-in fluids suitable for use in the present invention include biopolymers, such as xanthan and succinoglycan, cellulose and cellulose derivatives, such as hydroxyethylcellulose, guar and guar derivatives, such as hydroxypropyl guar, and viscoelastic surfactants. In certain embodiments, the viscosifying agent may be included in the drill-in fluid in an amount sufficient to suspend any bridging agents and/or drill cuttings present in the drill-in fluid. In some embodiments, the viscosifying agent may present in the drill-in fluids in an amount of about 0.01% to about 5% by weight.

In some embodiments, the drill-in fluids suitable for use in the present invention further comprise a bridging agent. Generally, a bridging agent suitable for use in the present invention is a solid particulate that becomes suspended in the drill-in fluid and, as the drill-in fluid begins to form a filter cake within the subterranean formation, the bridging agent becomes distributed throughout the resulting filter cake, most preferably uniformly. Examples of suitable bridging agents may include latex polymers, graphite, calcium carbonate, dolomite, celluloses, micas, sand, ceramic particles and degradable materials. In those embodiments where degradable materials may be used in the bridging agents, the degradable material may undergo an irreversible degradation after a particular time period dictated by the characteristics of the particular degradable material utilized. This degradation, in effect, causes the degradable material to substantially be removed from the filter cake. As a result, voids are created in the filter cake. Removal of the degradable material from the filter cake allows produced fluids to flow more freely.

Nonlimiting examples of suitable degradable materials that may be used in conjunction with the present invention include but are not limited to degradable polymers, dehydrated compounds, and/or mixtures of the two. Examples of suitable degradable polymers include, but are not limited to, polysaccharides, chitins, chitosans, proteins, orthoesters, aliphatic polyesters, polylactides, polyglycolides, polyε-carptolactones, polyhydroxybutyrates, polyanhydrides, aliphatic polycarbonates, polyorthoesters, polyamino acids, polyethylene oxides, polyphoshazenes, and mixtures thereof. Examples of suitable dehydrated compounds include, but are not limited to, anhydrous sodium tetraborate and anhydrous boric acid. In other embodiments, the drill-in fluid may comprise degradable hydratable gel particulates that can be broken down with breakers or through a change in pH; suitable degradable hydratable gel particulates are described in U.S. Pat. No. 5,680,900, which is hereby incorporated by reference.

In choosing the appropriate degradable material, one should consider the degradation products that will result. Also, these degradation products should not adversely affect other operations or components. For example, a boric acid derivative may not be included as a degradable material in the drill-in fluids of the present invention where such fluids utilize xanthan as the viscosifier, because boric acid and xanthan are generally incompatible. One of ordinary skill in the art, with the benefit of this disclosure, will be able to recognize when potential components of the drill-in fluids of the present invention would be incompatible or would produce degradation products that would adversely affect other operations or components.

Generally, the bridging agent may be present in the drill-in fluid in an amount sufficient to create a filter cake. In certain embodiments, the bridging agent may present in the drill-in fluid in an amount ranging from about 0.1% to about 10% by weight. In certain embodiments, the bridging agent may be present in the drill-in fluids in an amount sufficient to provide a fluid loss of less than about 15 mL in tests conducted according to the procedures set forth by API Recommended Practice (RP) 13. One of ordinary skill in the art with the benefit of this disclosure will recognize an optimum concentration of degradable material that provides desirable values in terms of enhanced ease of removal of the filter cake at the desired time without undermining the stability of the filter cake during its period of intended use.

Optionally, the drill-in fluids suitable for use in the present invention may comprise additional additives such as antifreeze agents, biocides, algaecides, pH control additives, oxygen scavengers, clay stabilizers, weighting agents, fluid loss agents and the like or any other additive that does not adversely affect the drill-in fluid. In some embodiments, optional additives may be included in the drill-in fluids in an amount in the range of about 0.001% to about 10% by weight of the drill-in fluid composition. One of ordinary skill in the art with the benefit of this disclosure will recognize that the compatibility of any given additive should be tested to ensure that it does not adversely affect the performance of the drill-in fluid.

In some embodiments, the drill-in fluid may further comprise a foaming agent. As used herein, the term “foamed” also refers to co-mingled fluids. In certain embodiments, it may be desirable that the drill-in fluid, among other things, provide enhanced placement of a water-based consolidating agent, to reduce the amount of aqueous fluid that is required, e.g., in water sensitive subterranean formations, and/or to reduce the need for a viscosifying agent. Various gases can be used for foaming the drill-in fluids of this invention, including, but not limited to, nitrogen, carbon dioxide, air, methane, and mixtures thereof. One of ordinary skill in the art with the benefit of this disclosure will be able to select an appropriate gas that may be used for foaming the drill-in fluids of the present invention. In some embodiments, the gas may be present in a drill-in fluid of the present invention in an amount in the range of about 5% to about 95% by volume of the drill-in fluid. In other embodiments, the gas may be present in a drill-in fluid of the present invention in an amount in the range of about 20% to about 80% by volume of the drill-in fluid. In some embodiments, the gas may be present in a drill-in fluid of the present invention in an amount in the range of about 30% to about 70% by volume of the drill-in fluid. The amount of gas to incorporate into the drill-in fluids may be affected by factors including the viscosity of the drill-in fluids and wellhead pressures involved in a particular application.

In those embodiments wherein it is desirable to foam the drill-in fluid used in the present invention, foaming agent surfactants, usually are nonionic surfactants, such as HY-CLEAN (HC-2)™ surface-active suspending agent, PEN-5M™, or AQF-2™ additive, all of which are commercially available from Halliburton Energy Services, Inc., of Duncan, Okla., may be used. Additional examples of foaming agents that may be used to foam and stabilize the drill-in fluids may include, but are not limited to, betaines, amine oxides, methyl ester sulfonates, alkylamidobetaines such as cocoamidopropyl betaine, alpha-olefin sulfonate, trimethyltallowammonium chloride, C₈ to C₂₂ alkylethoxylate sulfate and trimethylcocoammonium chloride. Other suitable foaming agents and foam stabilizing agents may be included as well, which will be known to those skilled in the art with the benefit of this disclosure. Examples of suitable foaming additives are available in U.S. Pat. Nos. 7,407,916, 7,287,594, 7,093,658, 7,124,822, 7,077,219, 7,040,419.

In some embodiments, the drill-in fluid used in the present invention may further comprise a weighting agent. Weighting agents are used to, among other things, increase the fluid density and thereby affect the hydrostatic pressure exerted by the fluid. Examples of suitable weighting agents include, but are not limited to, potassium chloride, sodium chloride, sodium bromide, calcium chloride, calcium bromide, ammonium chloride, zinc bromide, zinc formate, zinc oxide, and mixtures thereof.

In some embodiments, the drill-in fluids used in the present invention may further comprise a fluid loss control agent. Fluid loss control agents are used to, among other things, control leak off into a formation. A variety of fluid loss control additives can be included in the drill-in fluids of the present invention, including, inter alia, starch, starch ether derivatives, hydroxyethylcellulose, cross-linked hydroxyethylcellulose, a relative permeability modifier, and mixtures thereof. In certain preferred embodiments, the fluid loss control additive is starch. The fluid loss control additive is present in the drill-in fluids of the present invention in an amount sufficient to provide a desired degree of fluid loss control. More particularly, the fluid loss control additive is present in the drill-in fluid in an amount in the range of from about 0.01% to about 5% by weight. In certain embodiments, the fluid loss control additive is present in the drill-in fluid in an amount in the range of from about 0.5% to about 2% by weight.

Furthermore, in some embodiments, the drill-in fluids of the present invention may comprise a consolidating agent, as will be discussed in more detail below. Other additives may be suitable as well as might be recognized by one skilled in the art with the benefit of this disclosure.

### III. Suitable Reaming Fluids

The reaming fluids suitable for use in the present invention comprise an aqueous fluid and a viscosifying agent. In some embodiments, the reaming fluid may also comprise a bridging agent.

Suitable aqueous fluids that may be used in the reaming fluids suitable for use in the present invention include fresh water, salt water, brine, seawater, an aqueous fluid comprising a water soluble organic stabilizing compound, or any other aqueous fluid that, preferably, does not adversely react with the other components used in accordance with this invention or with the subterranean formation. In some preferred embodiments, the aqueous fluid comprises a brine.

Viscosifying agents that may be used in the reaming fluids suitable for use in the present invention include biopolymers, such as xanthan and succinoglycan, cellulose and cellulose derivatives, such as hydroxyethylcellulose, guar and guar derivatives, such as hydroxypropyl guar and viscoelastic surfactants. In certain embodiments, the viscosifying agent may be included in the reaming fluid in an amount sufficient to suspend the bridging agents present in the reaming fluid. In some embodiments, the viscosifying agent may present in the reaming fluids in an amount of about 0.01% to about 5% by weight.

In some embodiments, the reaming fluids suitable for use in the present invention further comprise a bridging agent. Examples of suitable bridging agents may include latex polymers, graphite, calcium carbonate, dolomite, celluloses, micas, sand, ceramic particles and degradable materials. In those embodiments where degradable materials may be used in the bridging agents, the degradable material may undergo an irreversible degradation after a particular time period dictated by the characteristics of the particular degradable material utilized. This degradation, in effect, causes the degradable material to substantially be removed from the filter cake. As a result, voids are created in the filter cake. Removal of the degradable material from the filter cake allows produced fluids to flow more freely.

Nonlimiting examples of suitable degradable materials that may be used in conjunction with the present invention include but are not limited to degradable polymers, dehydrated compounds, and/or mixtures of the two. Examples of suitable degradable polymers include, but are not limited to, polysaccharides, chitins, chitosans, proteins, orthoesters, aliphatic polyesters, polylactides, polyglycolides, polyε-carptolactones, polyhydroxybutyrates, polyanhydrides, aliphatic polycarbonates, polyorthoesters, polyamino acids, polyethylene oxides, polyphoshazenes, and mixtures thereof. Examples of suitable dehydrated compounds include, but are not limited to, anhydrous sodium tetraborate and anhydrous boric acid. In other embodiments, the reaming fluid may comprise degradable hydratable gel particulates that can be broken down with breakers or through a change in pH; suitable degradable hydratable gel particulates are described in U.S. Pat. No. 5,680,900, which is hereby incorporated by reference.

As stated above with respect to drill-in fluids, one should consider the degradation products that will result when choosing an appropriate degradable material. Also, these degradation products should not adversely affect other operations or components. One of ordinary skill in the art, with the benefit of this disclosure, will be able to recognize when potential components of the reaming fluids of the present invention would be incompatible or would produce degradation products that would adversely affect other operations or components.

Generally, the bridging agent may optionally be present in the reaming fluid in an amount sufficient to create a filter cake. In certain embodiments, the bridging agent may present in the reaming fluid in an amount ranging from about 0.1% to about 10% by weight. In certain embodiments, the bridging agent may be present in the reaming fluids in an amount sufficient to provide a fluid loss of less than about 15 mL in tests conducted according to the procedures set forth by API Recommended Practice (RP) 13. One of ordinary skill in the art with the benefit of this disclosure will recognize an optimum concentration of degradable material that provides desirable values in terms of enhanced ease of removal of the filter cake at the desired time without undermining the stability of the filter cake during its period of intended use.

Optionally, the reaming fluids suitable for use in the present invention may comprise additional additives such as antifreeze agents, biocides, algaecides, pH control additives, oxygen scavengers, clay stabilizers, weighting agents, fluid loss agents and the like or any other additive that does not adversely affect the reaming fluid. In some embodiments, optional additives may be included in the reaming fluids in an amount in the range of about 0.001% to about 10% by weight of the reaming fluid composition. One of ordinary skill in the art with the benefit of this disclosure will recognize that the compatibility of any given additive should be tested to ensure that it does not adversely affect the performance of the reaming fluid.

In some embodiments, the reaming fluids used in the present invention may further comprise a fluid loss control agent. Fluid loss control agents are used to, among other things, control leak off into a formation. A variety of fluid loss control additives can be included in the reaming fluids of the present invention, including, inter alia, starch, starch ether derivatives, hydroxyethylcellulose, cross-linked hydroxyethylcellulose, a relative permeability modifier, and mixtures thereof. In certain preferred embodiments, the fluid loss control additive is starch. The fluid loss control additive is present in the reaming fluids of the present invention in an amount sufficient to provide a desired degree of fluid loss control. More particularly, the fluid loss control additive is present in the reaming fluid in an amount in the range of from about 0.01% to about 5% by weight. In certain embodiments, the fluid loss control additive is present in the reaming fluid in an amount in the range of from about 0.5% to about 2% by weight.

Furthermore, in some embodiments, the reaming fluids of the present invention may comprise a consolidating agent, as will be discussed in more detail below. In those embodiments where a consolidating agent is present in the reaming fluid, it may be desirable to include a bridging agent that is compatible with the consolidating agent in the reaming fluid.

Other additives may be suitable as well as might be recognized by one skilled in the art with the benefit of this disclosure

### IV. Suitable Consolidating Agents

As mentioned above, embodiments of the present invention comprise consolidating the near well-bore region of a well bore using a consolidating agent. In some embodiments, the consolidating agent may be a component of a drill-in fluid. In some embodiments, the consolidating agent may be a component of a reaming fluid.

The consolidating agents may be present in a drill-in fluid or reaming fluid of the present invention in an amount in the range of about 0.05% to about 80% by weight of the fluid. In some embodiments, the consolidating agent may be present in the fluid in an amount in the range of about 0.1% to about 5% by weight of the fluid. In some embodiments, the consolidating agent may in the form of an emulsion. Examples of suitable consolidating agent emulsion compositions may be described in U.S. Patent Publication No. 2007/0289781, which is hereby incorporated by reference. The amount of consolidating agent included in a particular fluid may depend upon, among other factors, the composition and/or temperature of the subterranean formation, the chemical composition of formations fluids, flow rate of fluids present in the formation, the effective porosity and/or permeability of the subterranean formation, pore throat size and distribution, and the like. Furthermore, the concentration of the consolidating agent can be varied to either enhance bridging and thus provide for a more rapid coating of the consolidating agent or to minimize bridging and thus allow deeper penetration into the subterranean formation. It is within the ability of one skilled in the art, with the benefit of this disclosure, to determine the amount of consolidating agent to include in the fluids of the present invention to achieve the desired results.

In one embodiment, a consolidating agent suitable for use in the fluids used in the present invention comprises a two-component epoxy based resin comprising (1) a liquid hardenable resin and (2) a liquid hardening agent component. Solvents are not required for use in the consolidating agents used in the present invention.

The liquid hardenable resins suitable for use in the present invention include, but are not limited to, organic resins such as bisphenol A diglycidyl ether resins, butoxymethyl butyl glycidyl ether resins, bisphenol A-epichlorohydrin resins, bisphenol F resins, polyepoxide resins, novolak resins, polyester resins, phenol-aldehyde resins, urea-aldehyde resins, furfuryl alcohol, furan resins, urethane resins, glycidyl ether resins, other epoxide resins and combinations thereof. In some embodiments, the hardenable resin may comprise a urethane resin. Examples of suitable urethane resins may comprise a polyisocyanate component and a polyhydroxy component. Examples of suitable hardenable resins, including urethane resins, which may be suitable for use in the methods of the present invention, include those described in U.S. Pat. Nos. 6,582,819; 4,585,064; 6,677,426; and 7,153,575; the relevant disclosures of which are herein incorporated by reference.

The second component used in suitable consolidating agents is a liquid hardening agent component, which is comprised of a hardening agent and a surfactant. In some embodiments, the hardening agent component may further comprise a silane coupling agent.

Examples of the hardening agents that can be used in the liquid hardening agent component include, but are not limited to, cyclo-aliphatic amines, such as piperazine, derivatives of piperazine (e.g., aminoethylpiperazine) and modified piperazines; aromatic amines, such as methylene dianiline, derivatives of methylene dianiline and hydrogenated forms, and 4,4′-diaminodiphenyl sulfone; aliphatic amines, such as ethylene diamine, diethylene triamine, triethylene tetraamine, and tetraethylene pentaamine; imidazole; pyrazole; pyrazine; pyrimidine; pyridazine; 1H-indazole; purine; phthalazine; naphthyridine; quinoxaline; quinazoline; phenazine; imidazolidine; cinnoline; imidazoline; 1,3,5-triazine; thiazole; pteridine; indazole; amines; polyamines; amides; polyamides; 2-ethyl-4-methyl imidazole; and combinations thereof. The chosen hardening agent often effects the range of temperatures over which a hardenable resin is able to cure. By way of example and not of limitation, in subterranean formations having a temperature of about 60° F. to about 250° F., amines and cyclo-aliphatic amines such as piperidine, triethylamine, tris(dimethylaminomethyl)phenol, and dimethylaminomethyl)phenol may be preferred. In subterranean formations having higher temperatures, 4,4′-diaminodiphenyl sulfone may be a suitable hardening agent. Hardening agents that comprise piperazine or a derivative of piperazine have been shown capable of curing various hardenable resins from temperatures as low as about 50° F. to as high as about 350° F.

The hardening agent used may be included in the liquid hardening agent component in an amount sufficient to at least partially harden the resin composition. In some embodiments of the present invention, the hardening agent used is included in the liquid hardening agent component in the range of about 0.1% to about 95% by weight of the liquid hardening agent component. In other embodiments, the hardening agent used may be included in the liquid hardening agent component in an amount of about 15% to about 85% by weight of the liquid hardening agent component. In other embodiments, the hardening agent used may be included in the liquid hardening agent component in an amount of about 15% to about 55% by weight of the liquid hardening agent component.

Any surfactant compatible with the hardening agent and capable of facilitating the coating of the resin onto particulates in the subterranean formation may be used in the liquid hardening agent component. Such surfactants include, but are not limited to, an alkyl phosphonate surfactant (e.g., a C₁₂-C₂₂ alkyl phosphonate surfactant), an ethoxylated nonyl phenol phosphate ester, one or more cationic surfactants, and one or more nonionic surfactants. Mixtures of one or more cationic and nonionic surfactants also may be suitable. Examples of such surfactant mixtures are described in U.S. Pat. No. 6,311,773, the relevant disclosure of which is incorporated herein by reference. The surfactant or surfactants that may be used are included in the liquid hardening agent component in an amount in the range of about 1% to about 10% by weight of the liquid hardening agent component.

The optional silane coupling agent may be used, among other things, to act as a mediator to help bond the resin to formation particulates. The term “silane coupling agent” as used herein refers to a compound with have at least two reactive groups of different types bonded to a silicon atom. One of the reactive groups of different types is reactive with various inorganic materials such as glass, metals, silica sand and the like and may form a chemical bond with the surface of such inorganic materials; while the other of the reactive group is reactive with various kinds of organic materials and may form a chemical bond with the surface of such organic materials. As a result, silane coupling agents are capable of providing chemical bonding between an organic material and an inorganic material.

While any silane coupling agent may be used, examples of silane coupling agents include, N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes, aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; and gamma-glycidoxypropyltrimethoxysilanes; vinyltrichlorosilane; vinyltris (beta-methoxyethoxy)silane; vinyltriethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta(aminoethyl)-raminopropyl-trimethoxysilane; N-beta(aminoethyl)-raminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; Vinyltrichlorosilane; Vinyltris(beta-methoxyethoxy)silane; Vinyltrimethoxysilane; r-metacryloxypropyltrimethoxysilan; beta-(3,4 epoxycyclohexyl)-ethyltrimethoxysila; r-glycidoxypropyltrimethoxysilane; r-glycidoxypropylmethylidiethoxysilane; N-beta(aminoethyl)-raminopropyltrimethoxysilane; N-beta(aminoethyl)-raminopropylmethyldimethoxysilane; r-aminopropyltriethoxysilane; N-phenyl-raminopropyltrimethoxysilane; r-mercaptopropyltrimethoxysilane; r-chloropropyltrimethoxysilane and combinations thereof.

The silane coupling agent may be included in the liquid hardening agent component in an amount capable of sufficiently bonding the resin to the particulate. In some embodiments of the present invention, the silane coupling agent used is included in the liquid hardening agent component in the range of about 0.1% to about 3% by weight of the liquid hardening agent component.

Other consolidating agents suitable for use in the present invention are furan-based resins. Suitable furan-based resins include, but are not limited to, furfuryl alcohol resins, furfural resins, mixtures furfuryl alcohol resins and aldehydes, and a mixture of furan resins and phenolic resins. Of these, furfuryl alcohol resins may be preferred. A furan-based resin may be combined with a solvent to control viscosity if desired. Suitable solvents for use in the furan-based consolidation fluids of the present invention include, but are not limited to 2-butoxy ethanol, butyl lactate, butyl acetate, tetrahydrofurfuryl methacrylate, tetrahydrofurfuryl acrylate, esters of oxalic, maleic and succinic acids, and furfuryl acetate. Of these, 2-butoxy ethanol is preferred. In some embodiments, the furan-based resins suitable for use in the present invention may be capable of enduring temperatures well in excess of 350° F. without degrading. In some embodiments, the furan-based resins suitable for use in the present invention are capable of enduring temperatures up to about 700° F. without degrading.

Optionally, the furan-based resins suitable for use in the present invention may further comprise a curing agent, inter alia, to facilitate or accelerate curing of the furan-based resin at lower temperatures. The presence of a curing agent may be particularly useful in embodiments where the furan-based resin may be placed within subterranean formations having temperatures below about 350° F. Examples of suitable curing agents include, but are not limited to, organic or inorganic acids, such as, inter alia, maleic acid, fumaric acid, sodium bisulfate, hydrochloric acid, hydrofluoric acid, acetic acid, formic acid, phosphoric acid, sulfonic acid, alkyl benzene sulfonic acids such as toluene sulfonic acid and dodecyl benzene sulfonic acid (“DDBSA”), and combinations thereof. In those embodiments where a curing agent is not used, the furan-based resin may cure autocatalytically.

To facilitate a better understanding of the present invention, the following example of certain aspects of some embodiments is given. In no way should the following example be read to limit, or define, the entire scope of the invention.

### EXAMPLE

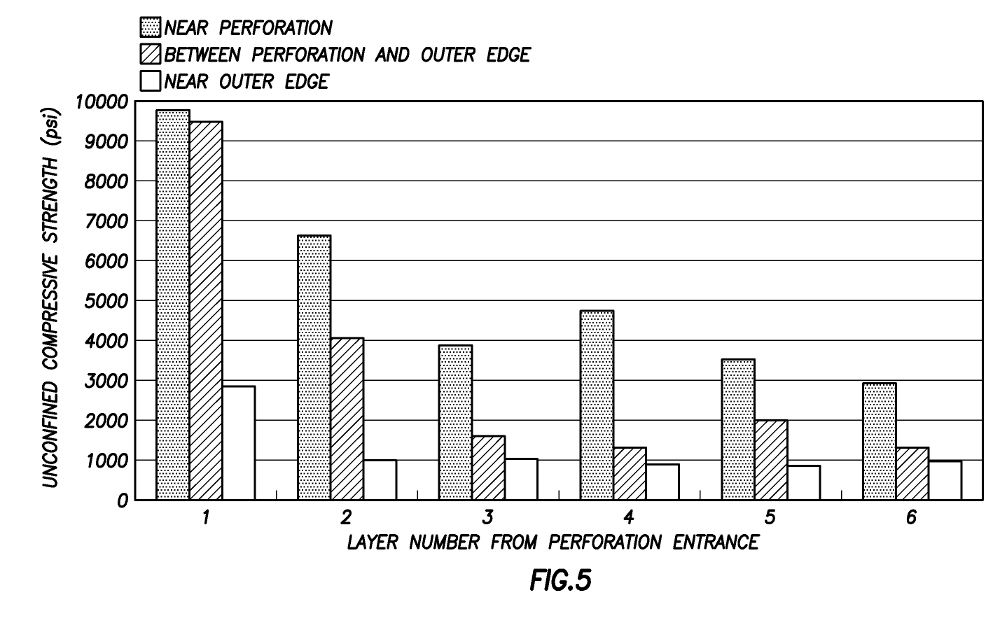

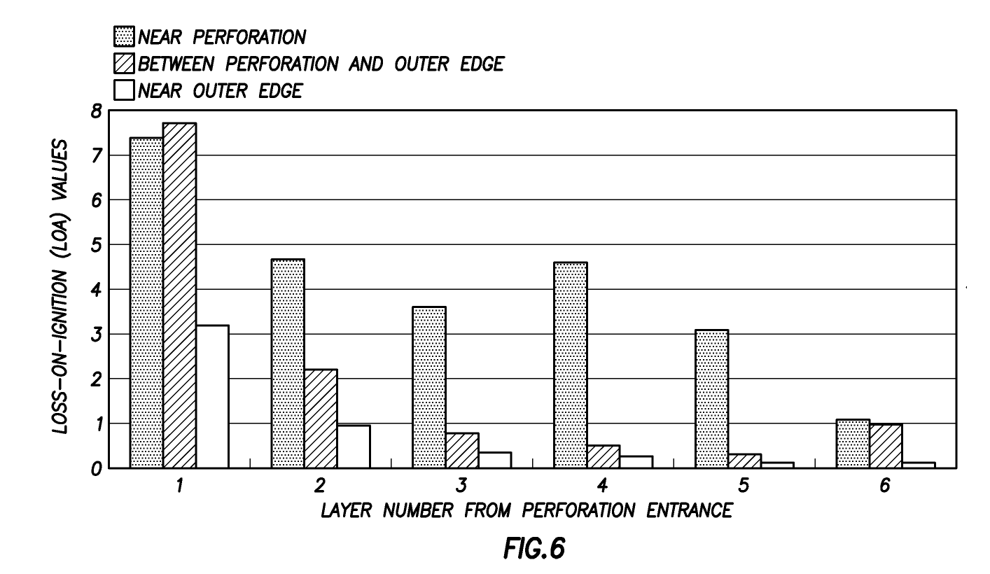

A Castlegate formation core, with a diameter of 4 inches and a length of 24 inches, was perforated with a shape charge to create a perforation entrance with a diameter of ½ inches and about 14 inches in length. A water-based epoxy resin emulsion system was used to treat the core through the perforation. The perforation was pre-heated to 175° F. and this temperature was maintained during the resin treatment. After the resin treatment, the treated core was shut in for 48 hours at temperature to allow the resin to completely cure. After curing, the core was then cut into wafers of 4-inch thick. Core plugs were obtained from each wafer at locations including near perforation, middle (between perforation and outer edge), and near outer edge. FIG. 5 provides a summary of the unconfined compressive strengths (UCS) and FIG. 6 provides a summary of the loss-on-ignition (LOI) values that were obtained from the core plugs to determine the effects of resin penetration into the formation matrix with respect to the length of the perforation and the length of the core.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method of comprising:
providing a drill-in fluid, a reaming fluid, and a consolidating agent;
drilling at least a portion of a subterranean formation with the drill-in fluid whereby a filter cake is formed on a surface of the subterranean formation;
reaming at least a portion of the subterranean formation with the reaming fluid whereby at least a portion of the filter cake is removed; and
consolidating at least a portion of the subterranean formation with the consolidating agent.

2. The method of claim 1 wherein the consolidating agent is a component of the drill-in fluid.

3. The method of claim 2 wherein the consolidating agent is present in the drill-in fluid in an amount of about 0.1% to about 5% by weight of the drill-in fluid.

4. The method of claim 1 wherein the consolidating agent is a component of the reaming fluid.

5. The method of claim 4 wherein the consolidating agent is present in the reaming fluid in an amount of about 0.1% to about 5% by weight of the reaming fluid.

6. The method of claim 1 wherein consolidating at least a portion of the formation occurs before reaming at least a portion of the formation.

7. The method of claim 1 wherein the drill-in fluid comprises an aqueous fluid and a viscosifying agent.

8. The method of claim 7 wherein the drill-in fluid further comprises at least one bridging agent selected from the group consisting of a latex polymer, graphite, calcium carbonate, dolomite, cellulose, mica, sand, a ceramic particle and a degradable material.

9. The method of claim 8 wherein the bridging agent comprises at least one degradable material selected from the group consisting of a polysaccharide, a chitin, a chitosan, a protein, an aliphatic polyester, a polylactide, a polyglycolide, a poly-ε-carptolactone, a polyhydrooxybutyrate, a polyanhydride, an aliphatic polycarbonate, a polyorthoester, a polyamino acid, a polyethylene oxide, a polyphoshazene, and a degradable hydratable gel particulate.

10. The method of claim 1 wherein the drill-in fluid is a foamed fluid.

11. The method of claim 1 wherein the reaming fluid comprises an aqueous fluid and a viscosifying agent.

12. The method of claim 1 wherein the consolidating agent is an epoxy based resin comprising at least one hardenable resin selected from the group consisting of a bisphenol A diglycidyl ether resin, a butoxymethyl butyl glycidyl ether resin, a bisphenol A-epichlorohydrin resin, a bisphenol F resin, a polyepoxide resin, a novolak resin, a polyester resin, a phenol-aldehyde resin, an urea-aldehyde resin, a furfuryl alcohol resin, a furan resin, a urethane resin, a glycidyl ether resin, other epoxide resins and combinations thereof.

13. A method of comprising:
providing a drill-in fluid comprising a consolidating agent;
providing a reaming fluid;
drilling at least a portion of a subterranean formation with the drill-in fluid comprising the consolidating agent;
allowing the consolidating agent to penetrate a surface of the subterranean formation so as to form a consolidated region;
allowing a filter cake to form on the surface of the subterranean formation; and
reaming at least a portion of the subterranean formation with the reaming fluid so as to remove at least a portion of the filter cake and expose at least a portion of the consolidated region.

14. The method of claim 13 wherein the consolidating agent is present in the drill-in fluid in an amount of about 0.1% to about 5% by weight of the drill-in fluid.

15. The method of claim 13 wherein the drill-in fluid further comprises at least one bridging agent selected from the group consisting of a latex polymer, graphite, calcium carbonate, dolomite, cellulose, mica, sand, a ceramic particle and a degradable material.

16. The method of claim 15 wherein the bridging agent comprises at least one degradable material selected from the group consisting of a polysaccharide, a chitin, a chitosan, a protein, an aliphatic polyester, a polylactide, a polyglycolide, a poly-ε-carptolactone, a polyhydrooxybutyrate, a polyanhydride, an aliphatic polycarbonate, a polyorthoester, a polyamino acid, a polyethylene oxide, a polyphoshazene, and a degradable hydratable gel particulate.

17. The method of claim 13 wherein the drill-in fluid is a foamed fluid.

18. A method of comprising:
providing a drill-in fluid;
providing a reaming fluid comprising a consolidating agent;
drilling at least a portion of a subterranean formation with the drill-in fluid;
allowing a filter cake to form on the surface of the subterranean formation;
reaming at least a portion of the subterranean formation with the reaming fluid comprising the consolidating agent; and
allowing the consolidating agent to penetrate a surface of the subterranean formation so as to form a consolidated region.

19. The method of claim 18 wherein the consolidating agent is present in the reaming fluid in an amount of about 0.1% to about 5% by weight of the reaming fluid.

20. The method of claim 18 wherein the consolidating agent is an epoxy based resin comprising at least one hardenable resin selected from the group consisting of a bisphenol A diglycidyl ether resin, a butoxymethyl butyl glycidyl ether resin, a bisphenol A-epichlorohydrin resin, a bisphenol F resin, a polyepoxide resin, a novolak resin, a polyester resin, a phenol-aldehyde resin, an urea-aldehyde resin, a furfuryl alcohol resin, a furan resin, a urethane resin, a glycidyl ether resin, other epoxide resins and combinations thereof.
